(19) United States
(12) Patent Application Publication
(10) Pub. No.: US 2025/0326395 A1
(43) Pub. Date: Oct. 23, 2025

(54) Apparatus for Controlling Driving of Autonomous Vehicle and Method Thereof

(71) Applicants: Hyundai Motor Company, Seoul (KR); Kia Corporation, Seoul (KR)

(72) Inventors: Jeong Woo Kim, Hwaseong-Si (KR); Sung Yoon Yeo, Hwaseong-Si (KR); Seung Jooon Lee, Hwaseong-Si (KR); Su Jung Yoo, Hwaseong-Si (KR); Beom Jun Kim, Hwaseong-Si (KR)

(21) Appl. No.: 18/935,826

(22) Filed: Nov. 4, 2024

(30) Foreign Application Priority Data
Apr. 17, 2024 (KR) 10-2024-0051535

(51) Int. Cl. B60W 30/14; B60W 10/188; B60W 50/00; B60W 60/00

(52) U.S. Cl. CPC B60W 30/146; B60W 10/188; B60W 50/0098; B60W 60/0015; B60W 2050/0083; B60W 2520/10; B60W 2554/4042; B60W 2555/60

(57) ABSTRACT

An apparatus for controlling autonomous driving of a vehicle is introduced. The apparatus may comprise a controller configured to determine, in a merging section on a road, at least one area of a safety area, a yield area, or a stop area, wherein the safety area may comprise a first part of the merging section designated for vehicles that have a right of way, the yield area may comprise a second part of the merging section designated for vehicles that should yield to traffic on the road, and the stop area may comprise a third part of the merging section designated for vehicles that should stop before merging onto the road, and determine a driving strategy of the vehicle for the at least one area, and a brake configured to, based on the driving strategy, adjust a speed of the vehicle.

### CROSS-REFERENCE TO RELATED APPLICATION

This application claims the benefit of priority to Korean Patent Application No. 10-2024-0051535, filed in the Korean Intellectual Property Office on Apr. 17, 2024, the entire contents of which are incorporated herein by reference.

### TECHNICAL FIELD

The present disclosure relates to a driving strategy for an autonomous vehicle applied to various types of merging sections on a road.

### BACKGROUND

The matters described in this Background section are only for enhancement of understanding of the background of the disclosure, and should not be taken as acknowledgement that they correspond to prior art already known to those skilled in the art.

In general, an autonomous vehicle may follow a set path or reach a set target point by having an autonomous controller recognize and determine the current state and surrounding environment of the vehicle on behalf of the driver.

Such an autonomous vehicle refers to vehicles equipped with a specific autonomous driving technology level. In order to check the performance and safety of an autonomous vehicle, a standard is used to evaluate the level of the autonomous driving system installed on the vehicle by a certain standard, and to this end, an autonomous driving technology level may be used. Most autonomous driving technologies installed in mass-produced vehicles may be at level 2. Level 3 or higher autonomous driving technology. Level 5 autonomous vehicles may have an unlimited operational design area, so it may not be practical to realize them in the short term. Therefore, the main targets for technology development and safety assurance may be level 3 and level 4. In particular, level 3 has issues with ensuring safety if switching control and level 4 uses the system to be fully responsible for the operation design area, so safety is to be secured first.

For the level 3 autonomous vehicle safety standard, when using the lane keeping function, the maximum speed and minimum safe distance from the vehicle in front may be set according to detection performance to ensure driving safety. In addition, standards for switching control by situation in abnormal situations and standards for responding with maximum deceleration and emergency steering in accordance with emergency operation standards in emergency situations may be set.

In particular, with regard to control switching, if there is no response from the driver within a specified time period from the time the drive switching request is made, risk-minimizing operation may start automatically thereafter, and the warning of the drive switching request may be performed by selecting between visual and auditory, visual and tactile, or visual and auditory and tactile. In addition, the intensity of the warning may begin to increase within a specified time period after the drive switching request, and the drive switching request may be stopped when the driver takes driving control or starts risk-minimizing driving.

Level 3 or level 4 autonomous vehicles may not have a driving strategy that may alleviate the discomfort felt by occupants in the autonomous vehicle due to merging vehicles at various types of merging sections on a road. A solution to the shortcomings of level 3 or level 4 autonomous vehicles, is presented.

### SUMMARY

According to the present disclosure, an apparatus for controlling autonomous driving of a vehicle, the apparatus may comprise a controller configured to determine, in a merging section on a road, at least one area of a safety area, a yield area, or a stop area, wherein the safety area may comprise a first part of the merging section designated for vehicles that have a right of way, the yield area may comprise a second part of the merging section designated for vehicles that should yield to traffic on the road, and the stop area may comprise a third part of the merging section designated for vehicles that should stop before merging onto the road, and determine a driving strategy of the vehicle for the at least one area, and a brake configured to, based on the driving strategy, adjust a speed of the vehicle.

The apparatus, wherein the controller is configured to set the safety area in the merging section.

The apparatus, wherein the controller is configured to set, based on a speed limit of a main part of the road and a speed limit of the merging section, the safety area.

The apparatus, wherein the controller is configured to, before entering the safety area, reduce the speed of the vehicle to a speed associated with the merging section, and determine, based on an average speed of vehicles within the safety area, the speed of the vehicle.

The apparatus, wherein the controller is configured to set the safety area and the yield area in the merging section.

The apparatus, wherein the controller is configured to set, based on a speed limit of a main part of the road and a speed limit of the merging section, the yield area, and set a preset distance from a start point of the yield area in a direction of the vehicle as an end point of the safety area.

The apparatus, wherein the controller is configured to, before entering the safety area, reduce the speed of the vehicle to a speed associated with the merging section, and determine, based on an average speed of vehicles from a start point of the safety area to an end point of the merging section, the speed of the vehicle.

The apparatus, wherein the controller is configured to detect another vehicle expected to arrive at an end point of the merging section before the vehicle on the merging section enters the yield area, and reduce the speed of the vehicle to a speed lower than a speed associated with the safety area.

The apparatus, wherein the controller is configured to set the safety area, the yield area, and the stop area in the merging section.

The apparatus, wherein the controller is configured to set a preset first distance from an end point of the merging section in a direction of the vehicle as a start point of the stop area, set a preset second distance from a start point of the stop area in the direction of the vehicle as an end point of the yield area, and set a preset third distance from a start point of the yield area in the direction of the vehicle as an end point of the safety area.

The apparatus, wherein the controller is configured to, before entering the safety area, reduce the speed of the vehicle to a speed associated with the merging section, and determine, based on an average speed of vehicles from a start point of the safety area to an end point of the merging section, the speed of the vehicle.

The apparatus, wherein the controller is configured to detect another vehicle expected to arrive at an end point of the merging section before the vehicle enters the yield area, and reduce the speed of the vehicle to a speed lower than a speed associated with the safety area.

The apparatus, wherein the controller is configured to stop, based on the vehicle entering the stop area, the vehicle to allow another vehicle on the merging section to enter a main part of the road.

According to the present disclosure, a method performed by an apparatus for controlling autonomous driving of a vehicle, the method may comprise determining, in a merging section on a road, at least one area of a safety area, a yield area, and a stop area, wherein the safety area may comprise a first part of the merging section designated for vehicles that have a right of way, the yield area may comprise a second part of the merging section designated for vehicles that should yield to traffic on the road, and the stop area may comprise a third part of the merging section designated for vehicles that should stop before merging onto the road, determining a driving strategy of the vehicle for the at least one area, and adjusting, based on the driving strategy, a speed of the vehicle.

The method, wherein the determining the driving strategy may comprise setting, based on a speed limit of a main part of the road and a speed limit of the merging section, the safety area in the merging section, before entering the safety area, reducing the speed of the vehicle to a speed associated the merging section, and determining, based on an average speed of vehicles on the safety area, the speed of the vehicle.

The method, wherein the determining the driving strategy may comprise setting, based on a speed limit of a main part of the road and a speed limit of the merging section, the yield area, setting a preset distance from a start point of the yield area in a direction of the vehicle as an end point of the safety area, before entering the safety area, reducing the speed of the vehicle to a speed associated with the merging section, and determining, based on an average speed of vehicles from a start point of the safety area to an end point of the merging section, the speed of the vehicle.

The method, wherein the determining the driving strategy may comprise detecting another vehicle expected to arrive at an end point of the merging section before the vehicle on the merging section enters the yield area, and reducing the speed of the vehicle to a speed lower than a speed associated with the safety area.

The method, wherein the determining the driving strategy may comprise setting the safety area, the yield area, and the stop area in the merging section.

The method, wherein the setting the safety area, the yield area, and the stop area may comprise setting a preset first distance from an end point of the merging section in a direction of the vehicle as a start point of the stop area, setting a preset second distance from a start point of the stop area in the direction of the vehicle as an end point of the yield area, and setting a preset third distance from a start point of the yield area in the direction of the vehicle as an end point of the safety area.

The method, wherein the determining the driving strategy may comprise, before entering the safety area, reducing the speed of the vehicle to a speed associated with the merging section, determining, based on an average speed of vehicles from a start point of the safety area to an end point of the merging section, the speed of the vehicle, detecting another vehicle expected to arrive at an end point of the merging section before the vehicle enters the yield area, reducing the speed of the vehicle to a speed lower than a speed associated with the safety area, and stopping, based on the vehicle entering the stop area, the vehicle to allow the other vehicle to enter a main part of the road.

### BRIEF DESCRIPTION OF THE DRAWINGS

The above and other objects, features and advantages of the present disclosure will be more apparent from the following detailed description taken in conjunction with the accompanying drawings:

FIG. 1 shows an example of an autonomous vehicle to which an example of the present disclosure is applied;

FIG. 2 shows an example of an apparatus for controlling driving of an autonomous vehicle according to an example of the present disclosure;

FIG. 3 shows an example of a safety area set in a first type of merging section on a map by a controller provided in an apparatus for controlling driving of an autonomous vehicle according to an example of the present disclosure;

FIG. 4 shows an example of a lookup table used to set a safety area in a merging section by a controller provided in an apparatus for controlling driving of an autonomous vehicle according to an example of the present disclosure;

FIG. 5 shows examples of a safety area and a yield area set in a second type of merging section on a map by a controller provided in an apparatus for controlling driving of an autonomous vehicle according to an example of the present disclosure;

FIG. 6 shows examples of a safety area, a yield area, and a stop area set in a third type of merging section on a map by a controller provided in an apparatus for controlling driving of an autonomous vehicle according to an example of the present disclosure;

FIG. 7 shows examples of a safety area and a yield area set in a fourth type of merging section on a map by a controller provided in an apparatus for controlling driving of an autonomous vehicle according to an example of the present disclosure;

FIG. 8 shows examples of a safety area, a yield area, and a stop area set in a fifth type of merging section on a map by a controller provided in an apparatus for controlling driving of an autonomous vehicle according to an example of the present disclosure;

FIG. 9 shows examples of a safety area, a yield area, and a stop area set in a sixth type of merging section on a map by a controller provided in an apparatus for controlling driving of an autonomous vehicle according to an example of the present disclosure;

FIG. 10 shows an example of a method of controlling driving of an autonomous vehicle according to an example of the present disclosure; and

FIG. 11 shows an example of a computing system for executing a method of controlling driving of an autonomous vehicle according to each example of the present disclosure.

### DETAILED DESCRIPTION

Hereinafter, some examples of the present disclosure will be described in detail with

reference to the exemplary drawings. In adding the reference numerals to the components of each drawing, it should be noted that the identical or equivalent component is designated by the identical numeral even when they are displayed on other drawings. Further, in describing the example of the present disclosure, a detailed description of the related known configuration or function will be omitted when it is determined that it interferes with the understanding of the example of the present disclosure.

In addition, terms, such as first, second, A, B, (a), (b) or the like may be used herein when describing components of the present disclosure. The terms are provided only to distinguish the elements from other elements, and the essences, sequences, orders, and numbers of the elements are not limited by the terms. In addition, unless defined otherwise, all terms used herein, including technical or scientific terms, have the same meanings as those generally understood by those skilled in the art to which the present disclosure pertains. The terms defined in the generally used dictionaries should be construed as having the meanings that coincide with the meanings of the contexts of the related technologies, and should not be construed as ideal or excessively formal meanings unless clearly defined in the specification of the present disclosure.

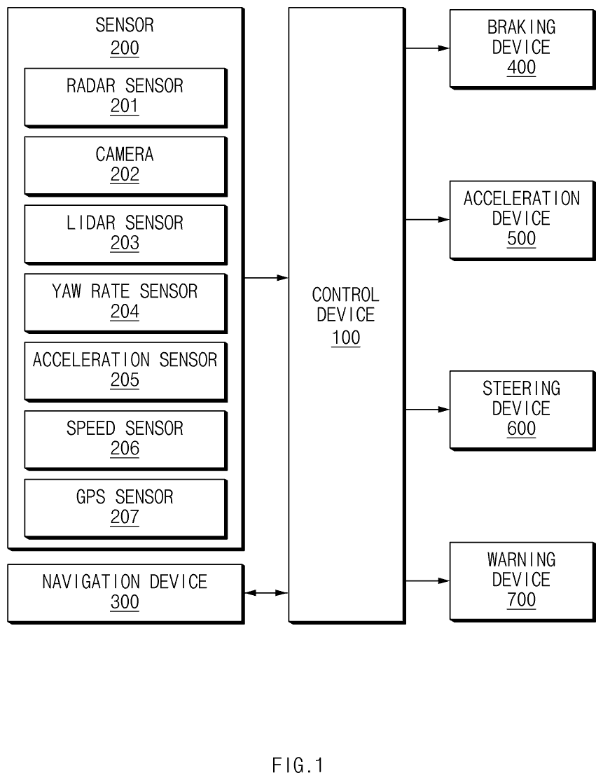

FIG. 1 shows an example of an autonomous vehicle to which an example of the present disclosure is applied.

An automation level of an autonomous driving vehicle may be classified as follows, according to the American Society of Automotive Engineers (SAE). At autonomous driving level 0, the SAE classification standard may correspond to “no automation,” in which an autonomous driving system is temporarily involved in emergency situations (e.g., automatic emergency braking) and/or provides warnings only (e.g., blind spot warning, lane departure warning, etc.), and a driver is expected to operate the vehicle. At autonomous driving level 1, the SAE classification standard may correspond to “driver assistance,” in which the system performs some driving functions (e.g., steering, acceleration, brake, lane centering, adaptive cruise control, etc.) while the driver operates the vehicle in a normal operation section, and the driver is expected to determine an operation state and/or timing of the system, perform other driving functions, and cope with (e.g., resolve) emergency situations. At autonomous driving level 2, the SAE classification standard may correspond to “partial automation,” in which the system performs steering, acceleration, and/or braking under the supervision of the driver, and the driver is expected to determine an operation state and/or timing of the system, perform other driving functions, and cope with (e.g., resolve) emergency situations. At autonomous driving level 3, the SAE classification standard may correspond to “conditional automation,” in which the system drives the vehicle (e.g., performs driving functions such as steering, acceleration, and/or braking) under limited conditions but transfer driving control to the driver when the required conditions are not met, and the driver is expected to determine an operation state and/or timing of the system, and take over control in emergency situations but do not otherwise operate the vehicle (e.g., steer, accelerate, and/or brake). At autonomous driving level 4, the SAE classification standard may correspond to “high automation,” in which the system performs all driving functions, and the driver is expected to take control of the vehicle only in emergency situations. At autonomous driving level 5, the SAE classification standard may correspond to “full automation,” in which the system performs full driving functions without any aid from the driver including in emergency situations, and the driver is not expected to perform any driving functions other than determining the operating state of the system. Although the present disclosure may apply the SAE classification standard for autonomous driving classification, other classification methods and/or algorithms may be used in one or more configurations described herein. One or more features associated with autonomous driving control may be activated based on configured autonomous driving control setting(s) (e.g., based on at least one of: an autonomous driving classification, a selection of an autonomous driving level for a vehicle, etc.).

As shown in FIG. 1, an autonomous vehicle to which an example of the present disclosure is applied may include a control device 100, a sensor 200 (e.g., camera, blind spot monitoring sensor, line departure warning sensor, parking sensor, light sensor, rain sensor, traction control sensor, anti-lock braking system sensor, tire pressure monitoring sensor, seatbelt sensor, airbag sensor, fuel sensor, emission sensor, throttle position sensor, etc.), a navigation device 300, a braking device 400, an acceleration device 500, a steering device 600, and a warning device 700.

The sensor 200, which is a group of sensors for detecting driving information of a target vehicle 50 as well as driving information of surrounding vehicles 60, may include a radar sensor 201, a camera 202, a lidar sensor 203, a yaw rate sensor 204, an acceleration sensor 205, a speed sensor 206, a GPS sensor 207, and the like.

The radar sensor 201, which is a sensor that irradiates a laser beam and detects an obstacle located around the vehicle through the beam that is reflected by the obstacle and returns, may measure the distance to an obstacle (e.g., the distance to a surrounding vehicle).

The camera 202 may include a front camera, a rear camera, a first rear side camera, and a second rear side camera to obtain surrounding images of the vehicle. In this case, the front camera may be mounted on the back of the room mirror mounted inside the vehicle and capture the front image of the vehicle. The rear camera may be mounted on the inside or outside of the rear of the vehicle to capture images of the rear of the vehicle. The first rear side camera may be mounted at the left side mirror of the vehicle to capture a first rear side image of the vehicle. The second rear side camera may be mounted at the right-side mirror of the vehicle to capture a second rear side image of the vehicle.

The lidar sensor 203, which is a type of environmental recognition sensor, may be mounted on the autonomous vehicle to shoot a laser in all directions while rotating and measure the location coordinates of a reflector based on the time it takes for the laser to be reflected and return. This LiDAR sensor 203 may measure the location and speed of each vehicle located on a merging road.

The yaw rate sensor 204 may detect a yaw moment generated if the vehicle turns (e.g., when turning to the right or left). The yaw rate sensor 204 may include a celsium crystal element therein. When the vehicle turns while moving, the celsium crystal element itself may generate a voltage while rotating, and measure the yaw rate of the vehicle based on the generated voltage.

The acceleration sensor 205, which is a sensor that measures acceleration of the vehicle, may include a lateral acceleration sensor and a longitudinal acceleration sensor. In this case, the lateral acceleration sensor may measure acceleration in the vertical axis (y-axis) direction (i.e., lateral direction) based on the moving direction (x-axis) of the vehicle. The lateral acceleration sensor may detect lateral acceleration that occurs if the vehicle turns (e.g., when turning to the right). In addition, the longitudinal acceleration sensor may measure acceleration in the moving direction (x-axis) of the vehicle.

The acceleration sensor 205, which is an element that detects changes in speed per unit time, may measure dynamic forces such as acceleration, vibration, shock, and the like by using the principles of inertial force, electrical deformation, and gyro.

The speed sensor 206 may be installed on each of the front and rear wheels of the vehicle to detect the speed of each wheel while driving.

The GPS sensor 207 may receive location information (GPS information) of the vehicle.

The navigation device 300 may calculate the current location of the vehicle by receiving location information from each satellite through a plurality of global positioning systems (hereinafter, referred to as “GPS”), display the calculated location on a map through map matching, receive a destination from a driver to perform a route search from the current location to the destination calculated according to a preset route search algorithm, match and display the searched route on the map, and guide the vehicle to the destination along the route.

The navigation device 300 may transmit map data to the control device 100. In this case, the map data may include road information necessary for driving and route guidance of the vehicle, such as a location of the road, a length of the road, a speed limit of the road, a merging section of the road, and the like. In addition, the map data may include lane location and lane information (ending point/junction point/merging point, and the like) for each road section.

A brake (e.g., braking device 400) may apply braking force (braking pressure) to the wheels of the vehicle by controlling the brake hydraulic pressure supplied to a wheel cylinder according to a braking signal output from the control device 100. The braking device 400 may adjust the speed of the target vehicle 50 according to the driving strategy determined by the controller 20.

The acceleration device 500 may control engine torque according to an engine control signal from the control device 100 or control motor torque according to a motor control signal.

The steering device 600, which is an electric power steering (EPS) system, may receive a target steering angle required for driving a vehicle and generate a torque to allow the wheels to be steered by following the target steering angle.

The warning device 700 may include a cluster, an audio video navigation (AVN) system, various lamp driving systems, a steering wheel vibration system, and the like, and may provide visual, auditory, and tactile warnings to the driver. In addition, the warning device 700 may use various lamps (a fog light or emergency light) of the vehicle to warn people around the vehicle (including drivers of other vehicles).

The control device 100, which is a processor (e.g., a circuit) that controls overall operations of the vehicle, may be a processor of an electronic control unit (ECU) that controls overall operations of the power system. The control device 100 may control the operations (braking, acceleration, steering, warning, and the like) of various modules and devices built into the vehicle. The control device 100 may control the operation of each component by generating control signals for controlling various modules and devices built into the vehicle.

The control device 100 may use a controller area network (CAN) of the vehicle. The CAN refers to a network system used for data transmission and control between vehicle ECUs. In detail, the CAN may transmit data through two-strand data wires that are twisted or shielded. The CAN may operate on the multi-master principle in which multiple ECUs perform master functions in a master/slave system. In addition, the control device 100 may communicate through an in-vehicle wired network such as a local interconnect network (LIN) of a vehicle, media-oriented system transport (MOST), and the like, or a wireless network such as Bluetooth, and the like.

The control device 100 may include a memory (e.g., a random-access memory (RAM), an embedded multi-media card (eMMC), a data scratch pad RAM (DSPR), a data local memory unit (DLMU), a local memory unit (LMU), or a default application memory (DAM), etc.) for storing a program that performs the operations described above and below and various data related thereto, a processor that executes programs stored in the memory, a hydraulic control unit (HCU), a micro controller unit (MCU), and the like. The control device 100 may be integrated into a system-on-chip (SOC) built into the vehicle and may be operated by a processor. However, because there is not only one system-on-chip built into the vehicle, but there may be multiple, the system-on-chip is not limited to being integrated into only one system-on-chip.

The control device 100 may be implemented with at least one type of storage medium among a flash memory type, hard disk type, multimedia card micro type, card type memory (e.g., an SD or XD memory, or the like), a random access memory (RAM), a static random access memory (SRAM), a read-only memory (ROM), an electrically erasable PROM (EEPROM), a programmable ROM (PROM), a magnetic memory, a magnetic disk, and an optical disk. However, the example is not limited thereto and may be implemented in another form known in the art.

The control device 100 may control the driving of the vehicle based on the map data (e.g., a merging section on a road) transmitted from the navigation device 300.

Specifically, the control device 100 may set at least one of a safety area, a yield area, and a stop area in each merging section for various types of merging sections on a road, and determine a driving strategy of the autonomous vehicle (or a target vehicle) for each area, thereby reducing an involved risk and/or the discomfort felt by occupants in the autonomous vehicle due to merging vehicles.

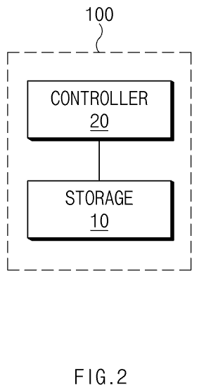

Hereinafter, the detailed configuration of the control device 100 will be described with reference to FIG. 2.

FIG. 2 shows an example of an apparatus for controlling driving of an autonomous vehicle according to an example of the present disclosure.

As shown in FIG. 2, an apparatus 100 for controlling driving of an autonomous vehicle according to an example of the present disclosure may include storage 10 and a controller 20. In this case, depending on a scheme of implementing the apparatus 100 for controlling driving of an autonomous vehicle according to an example of the present disclosure, components may be combined with each other to be implemented as one, or some components may be omitted.

Regarding each component, first, the storage 10 may store various logic, algorithms and programs required in the process of setting at least one of a safety area, a yield area, and a stop area in each merging section for various types of merging sections on a road, and determining a driving strategy of the autonomous vehicle (or a target vehicle) for each area. For example, the safety area is a first part of the merging section designated for vehicles that have the right of way. The yield area is a second part of the merging section designated for vehicles that should yield to traffic on the road.

The stop area is a third part of the merging section designated for vehicles that should stop before merging onto the road.

The storage 10 may store various logic, algorithms and programs required in the process of setting at least one of a safety area, a yield area, and a stop area in each merging section for various types of merging sections on a road, reducing the speed of the autonomous vehicle to a first speed corresponding to the merging section until just before entering the safety area, and determining the speed of the autonomous vehicle based on an average speed of merging vehicles (i.e., vehicles on a merging road) after entering the safety area. Various types of merging sections on the road may comprise on-ramp merges, lane reduction merges, T-intersection merges, acceleration lane merges, zipper merges, weaving sections, yield-controlled merges, roundabout merges, high-occupancy vehicle (HOV) lane merges, or exit-only lane merges, etc.

For example, on-ramp merge may occur if vehicles enter a highway or freeway from an on-ramp. Drivers may accelerate and merge into the main traffic flow, aligning with vehicles already traveling at higher speeds. On-ramp merges may help vehicles enter the roadway smoothly and safely by adjusting speed and position relative to existing traffic.

For example, a lane reduction merge may happen if the number of lanes decreases, such as if a three-lane road narrows to two lanes. Vehicles in the lane that is ending must merge into the adjacent lane. These sections may create bottlenecks if drivers do not merge smoothly, and proper signage is typically used to notify drivers in advance.

For example, in a T-intersection merge, vehicles from a side road may enter and merge into traffic on a main road, after coming to a stop or yielding. The merging vehicle may wait for an appropriate gap in traffic before entering the flow, which may require quick acceleration depending on traffic speed.

For example, acceleration lane merge may provide a dedicated lane for vehicles to gain speed before merging onto a highway or a main road. The acceleration lane may allow vehicles to match the speed of the flowing traffic, facilitating a smoother and safer merge. This type of merge may be applicable at highway on-ramps.

For example, a zipper merge may occur in situations where two lanes of traffic are being funneled into one, due to road construction or lane closures. Vehicles in both lanes take turns merging into the remaining lane, creating an alternating “zipper” pattern. This method may help reduce congestion and keep traffic flowing efficiently during lane reductions.

For example, weaving sections may have complex merging zones where vehicles entering a highway from an on-ramp are crossing paths with vehicles exiting the highway at a nearby off-ramp. The crisscrossing traffic patterns may demand careful attention and quick decision-making, as drivers navigate both merging and exiting movements in a short distance.

For example, a yield-controlled merge may be governed by yield signs, where vehicles slow down or stop to allow other traffic to merge safely. These merging sections may be applicable at intersections or highway entrance points where the merging traffic does not have the right of way and waits for an appropriate gap.

For example, in a roundabout merge, vehicles yield to traffic already circulating in the roundabout before entering. In the circular intersection, drivers find a gap and merge smoothly into the roundabout's flow of traffic. This type of merge may reduce the likelihood of head-on collisions and improve traffic flow in busy intersections.

For example, High-Occupancy Vehicle (HOV) Lane Merge is involved in merging into or out of an HOV lane, which is reserved for vehicles with multiple passengers. These lanes may be separated from general traffic by solid or dashed markings or even physical barriers. Vehicles find designated points to merge into or out of the HOV lane without disrupting the faster flow of traffic.

For example, exit-only lane merge may occur where vehicles choose between merging left into continuing traffic or remaining in an exit-only lane to leave the roadway. Drivers may make quick decisions to avoid missing the exit or causing a disruption in the flow of traffic. These sections may be applicable near highway off-ramps where signage directs vehicles accordingly.

The storage 10 may store various logic, algorithms and programs required in the process of setting at least one of a safety area, a yield area, and a stop area in each merging section for various types of merging sections on a road, reducing the speed of the autonomous vehicle to a first speed corresponding to the merging section until just before entering the safety area, determining the speed of the autonomous vehicle based on an average speed of merging vehicles (i.e., vehicles on a merging road) after entering the safety area, detecting a merging vehicle expected to arrive at an end point of the merging section before the autonomous vehicle among merging vehicles, and reducing the speed of the autonomous vehicle to a second speed corresponding to the merging section.

The storage 10 may store various logic, algorithms and programs required in the process of setting at least one of a safety area, a yield area, and a stop area in each merging section for various types of merging sections on a road, reducing the speed of the autonomous vehicle to a first speed corresponding to the merging section until just before entering the safety area, determining the speed of the autonomous vehicle based on an average speed of merging vehicles (i.e., vehicles on a merging road) after entering the safety area, detecting a merging vehicle expected to arrive at an end point of the merging section before the autonomous vehicle among merging vehicles, reducing the speed of the autonomous vehicle to a second speed corresponding to the merging section, and stopping the autonomous vehicle to allow a vehicle on the merging road to enter a main road in the stop area.

The controller 20 may be electrically connected to each component and may perform overall control such that each component performs its function. The controller 20 may be implemented in the form of hardware or software, or may be implemented in a combination of hardware and software. Preferably, the controller 20 may be implemented as a microprocessor, but is not limited thereto.

The controller 20 may set at least one of a safety area, a yield area, and a stop area in each merging section for various types of merging sections on a road, and determine a driving strategy of the autonomous vehicle (or a target vehicle) for each area. Where the road consists of a main road and a merging road.

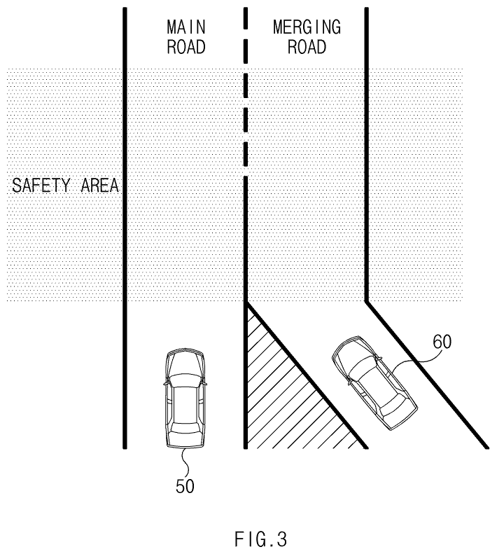

Hereinafter, the operation of the controller 20 will be described in detail with reference to FIGS. 3 to 9.

FIG. 3 shows an example of a safety area set in a first type of merging section on a map by a controller provided in an apparatus for controlling driving of an autonomous vehicle according to an example of the present disclosure. Where the merging section includes a main road and a merging road.

As shown in FIG. 3, because the first type of merging section is a section in which a merging road does not disappear but coexists with a main road, and a merging vehicle 60 travels on the merging road or changes to the main road, the controller 20 may set a safety area in the first type of merging section.

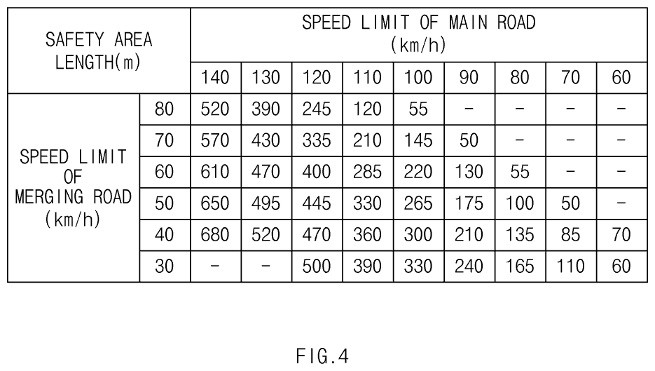

In this case, the controller 20 may determine the longitudinal length (or distance) of the safety area based on the speed limit of the main road and the speed limit of the merge road. For example, the controller 20 may determine the longitudinal length of the safety area within the first type of merging section based on the look-up table shown in FIG. 4.

FIG. 4 shows an example of a lookup table used to set a safety area in a merging section by a controller provided in an apparatus for controlling driving of an autonomous vehicle according to an example of the present disclosure.

As shown in FIG. 4, the look-up table records the longitudinal length (m) of the safety area corresponding to the speed limit (km/h) of the main road and the speed limit (km/h) of the merging road. For example, in a merging section where the speed limit of the main road is 110 km/h and the speed limit of the merging road is 60 km/h, the longitudinal length of the safety area is 285 m. For reference, there is no road where a merging section is located where the speed limit on the main road is 70 km/h and the speed limit on the merging road is 70 km/h.

Meanwhile, if the target vehicle 50 enters the safety area, the controller 20 may determine the speed ‘V’ of the target vehicle 50 based on Equation 1 below and control the target vehicle 50 to maintain the speed.

$$V = ( {ω}_{1} \times {V}_{l} ) + ( {ω}_{2} \times {V}_{a 1} ) \qquad [ Equation 1 ]$$

Where Vₗ represents the speed limit of the main road, Vₐ₁ represents the average speed of vehicles on the merging road within the safety area, ω₁ represents a weight (e.g., 0.6) that adjusts the speed limit of the main road, and ω₂ represents a weight (e.g., 0.4) that adjusts the average speed of vehicles.

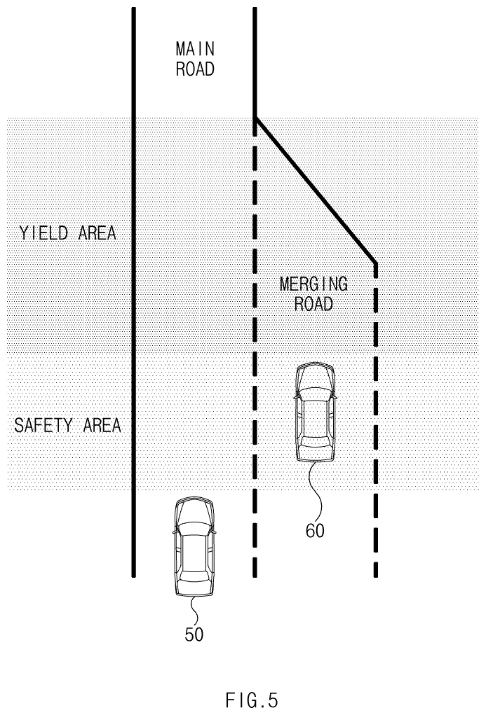

FIG. 5 shows examples of a safety area and a yield area set in a second type of merging section on a map by a controller provided in an apparatus for controlling driving of an autonomous vehicle according to an example of the present disclosure. Where the merging section includes a main road and a merging road.

As shown in FIG. 5, because the second type of merging section is a section in which the merging road disappears and the merging vehicle 60 changes from the merging road to the main road, the controller 20 may set a safety area and a yield area in the second type of merging section.

In this case, the controller 20 may set the yield area in the merging section based on the lookup table shown in FIG. 4. For example, if the speed limit of the main road is 100 km/h and the speed limit of the merging road is 80 km/h, the longitudinal length of the safety area in the merging section is 55 m. Accordingly, the controller 20 may set the area from the end point of the merging section (i.e., the end point of the yield area) to 55 m in the direction of the target vehicle 50 as the yield area, and then, may set the area from the start point of the yield area (i.e., the end point of the safety area) to the distance preset in the direction of the target vehicle 50 as the safety area.

In addition, if the target vehicle 50 enters the safety area, the controller 20 may determine the speed ‘V’ of the target vehicle 50 based on Equation 2 below and control the target vehicle 50 to maintain the speed.

$$V = ( {ω}_{1} \times {V}_{l} ) + ( {ω}_{2} \times {V}_{a 2} ) \qquad [ Equation 2 ]$$

Where Vₗ represents the speed limit of the main road, Vₐ₂ represents the average speed of vehicles on the merging road in the area from the start point of the safety area to the end point of the merging section (or the end point of the merging road), ω1 represents a first weight (e.g., 0.6) that adjusts the speed limit of the main road, and ω2 represents a second weight (e.g., 0.4) that adjusts the average speed of vehicles.

In addition, if the target vehicle 50 enters the yield area, the controller 20 may detect a vehicle expected to arrive at the end point of the merging section before the target vehicle 50 among the vehicles on the merging road, and if the vehicle is detected, the controller 20 may reduce the speed of the target vehicle 50 to a lower speed than the speed in the safety area. For example, if the speed in the safety area is 60 km/h, the speed in the yield area may be 50 km/h or 40 km/h.

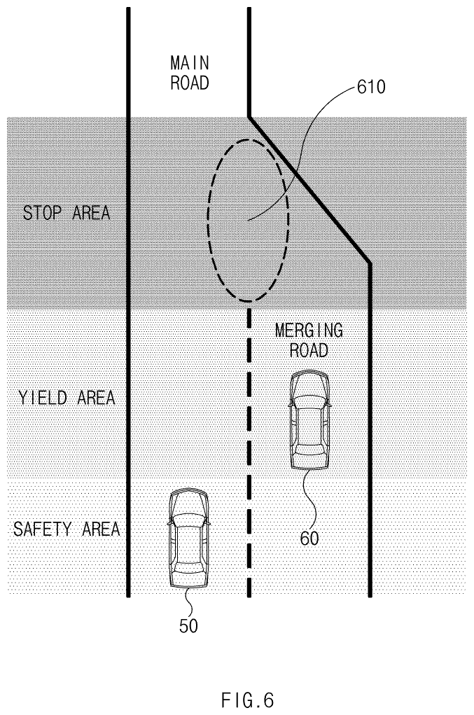

FIG. 6 shows examples of a safety area, a yield area, and a stop area set in a third type of merging section on a map by a controller provided in an apparatus for controlling driving of an autonomous vehicle according to an example of the present disclosure. Where the merging section includes a main road and a merging road.

As shown in FIG. 6, because the third type of merging section is a section in which the merging road disappears, there is no traffic line as indicated by reference numeral 610, and the merging vehicle 60 changes from the merging road to the main road, the controller 20 may set a safety area, a yield area, and a stop area in the third type of merging section.

In this case, the controller 20 may set the area from the end point of the merging section to the distance (e.g., 25 m) preset in the direction of the target vehicle 50 as the stop area, set the area from the start point of the stop area (i.e., the end point of the yield area) to the distance (e.g., 50 m) preset in the direction of the target vehicle 50 as the yield area, and set the area from the start point of the yield area (i.e., the end point of the safety area) to the distance (e.g., 100 m) preset in the direction of the target vehicle 50 as the safety area.

In addition, if the target vehicle 50 enters the safety area, the controller 20 may determine the speed ‘V’ of the target vehicle 50 based on Equation 2 and control the target vehicle 50 to maintain the speed.

In addition, if the target vehicle 50 enters the yield area, the controller 20 may detect a vehicle expected to arrive at the end point of the merging section before the target vehicle 50 among the vehicles on the merging road, and if the vehicle is detected, the controller 20 may reduce the speed of the target vehicle 50 to a lower speed than the speed in the safety area.

In addition, if the target vehicle 50 enters the stop area, the controller 20 may stop the target vehicle 50 to allow the merging vehicle 60 to enter the main road.

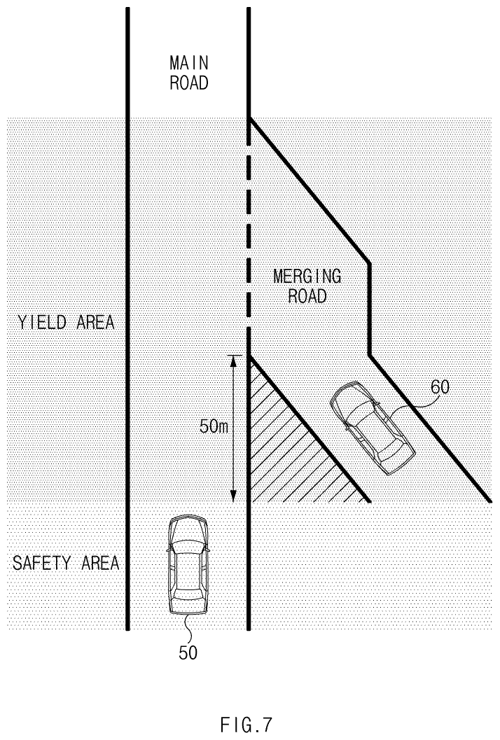

FIG. 7 shows examples of a safety area and a yield area set in a fourth type of merging section on a map by a controller provided in an apparatus for controlling driving of an autonomous vehicle according to an example of the present disclosure. Where the merging section includes a main road and a merging road.

As shown in FIG. 7, because the fourth type of merging section is a section in which the merging road where the merging start point may be known disappears, and the merging vehicle 60 changes from the merging road to the main road, the controller 20 may set a safety area and a yield area in the fourth type of merging section in the same manner as the second type of merging section.

The controller 20 may set a point that is spaced apart from the point where the merging vehicle 60 actually perform a lane change by a distance (e.g., 50 m) in the direction of the target vehicle 50 as the start point of the yield area (i.e., the end point of the safety area), set the end point of the merging section as the end point of the yield area, and set the area from the start point of the yield area to the distance (e.g., 100 m) preset in the direction of the target vehicle 50 as the safety area.

In addition, if the target vehicle 50 enters the safety area, the controller 20 may determine the speed ‘V’ of the target vehicle 50 based on Equation 2 and control the target vehicle 50 to maintain the speed.

In addition, if the target vehicle 50 enters the yield area, the controller 20 may detect a vehicle expected to arrive at the end point of the merging section before the target vehicle 50 among the vehicles on the merging road, and if the vehicle is detected, the controller 20 may reduce the speed of the target vehicle 50 to a lower speed than the speed in the safety area.

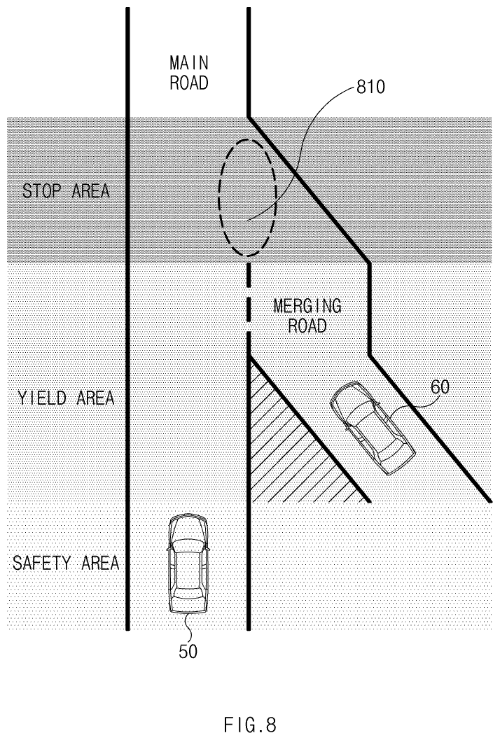

FIG. 8 shows examples of a safety area, a yield area, and a stop area set in a fifth type of merging section on a map by a controller provided in an apparatus for controlling driving of an autonomous vehicle according to an example of the present disclosure. Where the merging section includes a main road and a merging road.

As shown in FIG. 8, because the fifth type of merging section is a section in which the merging road where the merging start point may be known disappears, there is no traffic line as indicated by reference numeral 810, and the merging vehicle 60 changes from the merging road to the main road, the controller 20 may set a safety area, a yield area, and a stop area in the fifth type of merging section in the same manner as the third type of merging section.

In this case, the controller 20 may set the area from the end point of the merging section to the distance (e.g., 25 m) preset in the direction of the target vehicle 50 as the stop area, set the area from the start point of the stop area (i.e., the end point of the yield area) to the distance (e.g., 50 m) preset in the direction of the target vehicle 50 as the yield area, and set the area from the start point of the yield area (i.e., the end point of the safety area) to the distance (e.g., 100 m) preset in the direction of the target vehicle 50 as the safety area.

In addition, if the target vehicle 50 enters the safety area, the controller 20 may determine the speed ‘V’ of the target vehicle 50 based on Equation 2 and control the target vehicle 50 to maintain the speed.

In addition, if the target vehicle 50 enters the yield area, the controller 20 may detect a vehicle expected to arrive at the end point of the merging section before the target vehicle 50 among the vehicles on the merging road, and if the vehicle is detected, the controller 20 may reduce the speed of the target vehicle 50 to a lower speed than the speed in the safety area.

In addition, if the target vehicle 50 enters the stop area, the controller 20 may stop the target vehicle 50 to allow the merging vehicle 60 to enter the main road.

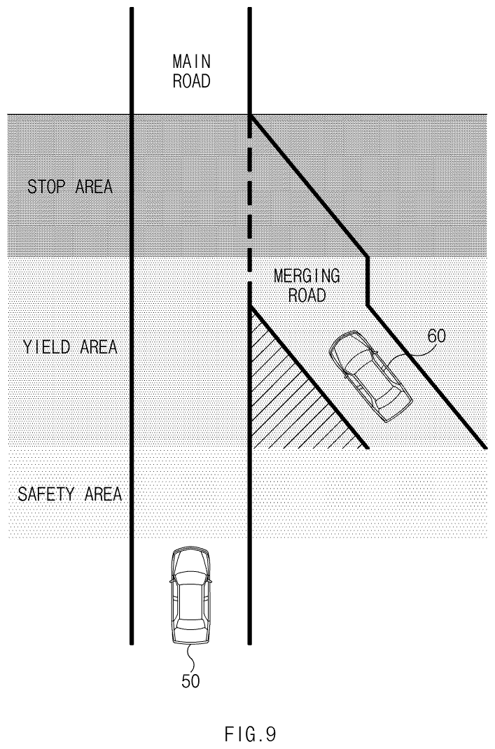

FIG. 9 shows examples of a safety area, a yield area, and a stop area set in a sixth type of merging section on a map by a controller provided in an apparatus for controlling driving of an autonomous vehicle according to an example of the present disclosure.

As shown in FIG. 9, because the sixth type of merging section is a very short section in which the merging vehicle 60 may merge into the main road and may immediately change from the merging road to the main road, the controller 20 may set a safety area, a yield area, and a stop area in the sixth type of merging section in the same manner as the third type of merging section. In this case, the controller 20 may set the area where the merging vehicle 60 merges actually

into the main road as the stop area, set the area from the start point of the stop area (i.e., the end point of the yield area) to the distance (e.g., 25 m) preset in the direction of the target vehicle 50 as the yield area, and set the area from the start point of the yield area (i.e., the end point of the safety area) to the distance (e.g., 50 m) preset in the direction of the target vehicle 50 as the safety area.

In addition, if the target vehicle 50 enters the safety area, the controller 20 may determine

the speed ‘V’ of the target vehicle 50 based on Equation 2 and control the target vehicle 50 to maintain the speed.

In addition, if the target vehicle 50 enters the yield area, the controller 20 may detect a vehicle expected to arrive at the end point of the merging section before the target vehicle 50 among the vehicles on the merging road, and if the vehicle is detected, the controller 20 may reduce the speed of the target vehicle 50 to a lower speed than the speed in the safety area.

In addition, if the target vehicle 50 enters the stop area, the controller 20 may stop the target vehicle 50 to allow the merging vehicle 60 to enter the main road.

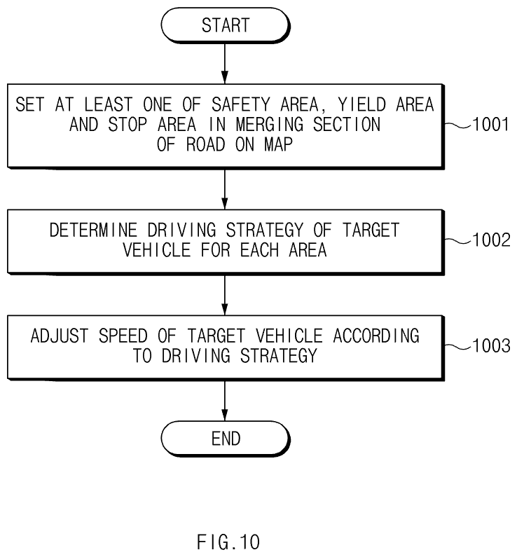

FIG. 10 shows an example of a method of controlling driving of an autonomous vehicle according to an example of the present disclosure. For convenience, FIG. 10 is described by way of an example in which the steps are performed by control circuitry (e.g., a control device 100). One, some, or all steps of the example method of FIG. 10, or portions thereof, may be performed by one or more other circuits. One or some, steps of the example method of FIG. 10 may be omitted, performed in other orders, and/or otherwise modified, and/or one or more additional steps may be added.

First, in 1001, the controller 20 sets at least one of a safety area, a yield area, and a stop area in a merging section of a road on a map.

Then, in 1002, the controller 20 determines the driving strategy of a target vehicle for each area.

Then, in 1003, the braking device 400 adjusts the speed of the target vehicle according to the driving strategy.

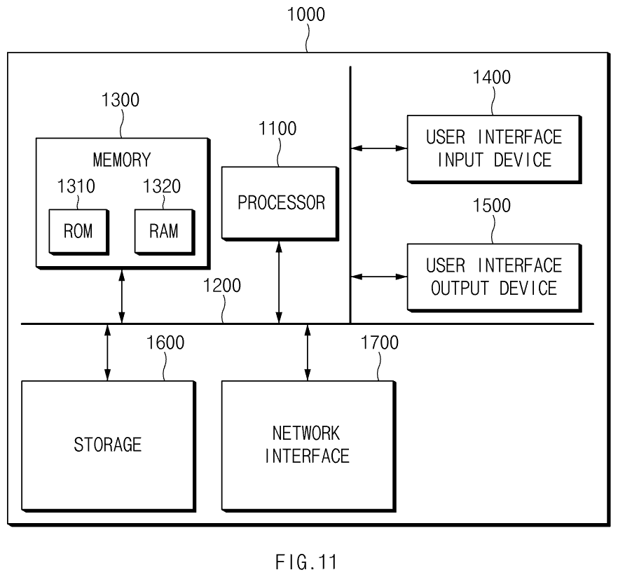

FIG. 11 shows an example of a computing system for executing a method of controlling driving of an autonomous vehicle according to each example of the present disclosure.

Referring to FIG. 11, a method of controlling driving of an autonomous vehicle according to an example of the present disclosure described above may be implemented through a computing system 1000. The computing system 1000 may include at least one processor 1100, a memory 1300, a user interface input device 1400, a user interface output device 1500, storage 1600, and a network interface 1700 connected through a system bus 1200.

The processor 1100 may be a central processing device (CPU) or a semiconductor device that processes instructions stored in the memory 1300 and/or the storage 1600. The memory 1300 and the storage 1600 may include various types of volatile or non-volatile storage media. For example, the memory 1300 may include a ROM (Read Only Memory) 1310 and a RAM (Random Access Memory) 1320.

The present disclosure has been made to solve the above-mentioned problems occurring in the prior art while advantages achieved by the prior art are maintained intact.

An example of the present disclosure provides an apparatus for controlling driving of an autonomous vehicle and a method thereof capable of reducing the discomfort felt by occupants in the autonomous vehicle due to merging vehicles by setting at least one of a safety area, a yield area, and a stop area in each merging section for various types of merging sections on a road, and determining a driving strategy of the autonomous vehicle (or a target vehicle) for each area.

Another example of the present disclosure provides an apparatus for controlling driving of an autonomous vehicle and a method thereof capable of reducing the discomfort felt by occupants in the autonomous vehicle due to merging vehicles by setting at least one of a safety area, a yield area, and a stop area in each merging section for various types of merging sections on a road, reducing the speed of the autonomous vehicle to a first speed corresponding to the merging section until just before entering the safety area, and determining the speed of the autonomous vehicle based on an average speed of merging vehicles (i.e., vehicles on a merging road) after entering the safety area.

Still another example of the present disclosure provides an apparatus for controlling driving of an autonomous vehicle and a method thereof capable of reducing the discomfort felt by occupants in the autonomous vehicle due to merging vehicles by setting at least one of a safety area, a yield area, and a stop area in each merging section for various types of merging sections on a road, reducing the speed of the autonomous vehicle to a first speed corresponding to the merging section until just before entering the safety area, determining the speed of the autonomous vehicle based on an average speed of merging vehicles (i.e., vehicles on a merging road) after entering the safety area, detecting a merging vehicle expected to arrive at an end point of the merging section before the autonomous vehicle among merging vehicles in the yield area, and further reducing the speed of the autonomous vehicle to a second speed corresponding to the merging section.

Still another example of the present disclosure provides an apparatus for controlling driving of an autonomous vehicle and a method thereof capable of reducing the discomfort felt by occupants in the autonomous vehicle due to merging vehicles by setting at least one of a safety area, a yield area, and a stop area in each merging section for various types of merging sections on a road, reducing the speed of the autonomous vehicle to a first speed corresponding to the merging section until just before entering the safety area, determining the speed of the autonomous vehicle based on an average speed of merging vehicles (i.e., vehicles on a merging road) after entering the safety area, detecting a merging vehicle expected to arrive at an end point of the merging section before the autonomous vehicle among merging vehicles in the yield area, further reducing the speed of the autonomous vehicle to a second speed corresponding to the merging section, and stopping the autonomous vehicle to allow a vehicle on the merging road to enter a main road in the stop area.

The technical problems to be solved by the present disclosure are not limited to the aforementioned problems, and any other technical problems not mentioned herein will be clearly understood from the following description by those skilled in the art to which the present disclosure pertains. Also, it may be easily understood that the objects and advantages of the present disclosure may be realized by the units and combinations thereof recited in the claims.

According to an example of the present disclosure, an apparatus for controlling driving of an autonomous vehicle includes a controller that sets at least one of a safety area, a yield area, and a stop area in a merging section on a road, and determines a driving strategy of a target vehicle for each area, and a braking device that adjusts a speed of the target vehicle according to the driving strategy.

According to an example, the controller may set the safety area in the merging section.

According to an example, the controller may set the safety area based on a speed limit of a main road and a speed limit of a merging road.

According to an example, the controller may reduce the speed of the target vehicle to a speed corresponding to the merging section until just before entering the safety area, and determine the speed of the target vehicle based on an average speed of vehicles on a merging road within the safety area after entering the safety area.

According to an example, the controller may set the safety area and the yield area in the merging section.

According to an example, the controller may set the yield area based on a speed limit of a main road and a speed limit of a merging road, and set a preset distance from a start point of the yield area in a direction of the target vehicle as the safety area.

According to an example, the controller may reduce the speed of the target vehicle to a speed corresponding to the merging section until just before entering the safety area, and determine the speed of the target vehicle based on an average speed of vehicles on a merging road within an area from a start point of the safety area to an end point of the merging section after entering the safety area.

According to an example, the controller may detect a vehicle expected to arrive at an end point of the merging section before the target vehicle among vehicles on a merging road if the target vehicle enters the yield area, and reduce the speed of the target vehicle to a speed lower than a speed in the safety area.

According to an example, the controller may set the safety area, the yield area, and the stop area in the merging section.

According to an example, the controller may set a preset first distance from an end point of the merging section in a direction of the target vehicle as the stop area, set a preset second distance from a start point of the stop area in the direction of the target vehicle as the yield area, and set a preset third distance from a start point of the yield area in the direction of the target vehicle as the safety area.

According to an example, the controller may reduce the speed of the target vehicle to a speed corresponding to the merging section until just before entering the safety area, and determine the speed of the target vehicle based on an average speed of vehicles on a merging road within an area from a start point of the safety area to an end point of the merging section after entering the safety area.

According to an example, the controller may detect a vehicle expected to arrive at an end point of the merging section before the target vehicle among vehicles on a merging road if the target vehicle enters the yield area, and reduce the speed of the target vehicle to a speed lower than a speed in the safety area.

According to an example, the controller may stop the target vehicle to allow a vehicle on a merging road to enter a main road if the target vehicle enters the stop area.

According to another example of the present disclosure, a method of controlling driving of an autonomous vehicle includes setting, by a controller, at least one of a safety area, a yield area, and a stop area in a merging section on a road, determining, by a controller, a driving strategy of a target vehicle for each area, and adjusting, by a braking device, a speed of the target vehicle according to the driving strategy.

According to an example, the determining of the driving strategy may include setting, by the controller, the safety area in the merging section based on a speed limit of a main road and a speed limit of a merging road, reducing, by the controller, the speed of the target vehicle to a speed corresponding to the merging section until just before entering the safety area, and determining, by the controller, the speed of the target vehicle based on an average speed of vehicles on the merging road within the safety area after entering the safety area.

According to an example, the determining of the driving strategy may include setting, by the controller, the yield area in the merging section based on a speed limit of a main road and a speed limit of a merging road, setting a preset distance from a start point of the yield area in a direction of the target vehicle as the safety area, reducing, by the controller, the speed of the target vehicle to a speed corresponding to the merging section until just before entering the safety area, and determining, by the controller, the speed of the target vehicle based on an average speed of vehicles on a merging road within an area from a start point of the safety area to an end point of the merging section after entering the safety area.

According to an example, the determining of the driving strategy may include detecting a vehicle expected to arrive at an end point of the merging section before the target vehicle among vehicles on a merging road if the target vehicle enters the yield area, and reducing the speed of the target vehicle to a speed lower than a speed in the safety area.

According to an example, the determining of the driving strategy may include setting, by the controller, the safety area, the yield area, and the stop area in the merging section.

According to an example, the setting of the safety area, the yield area, and the stop area may include setting, by the controller, a preset first distance from an end point of the merging section in a direction of the target vehicle as the stop area, setting, by the controller, a preset second distance from a start point of the stop area in the direction of the target vehicle as the yield area, and setting, by the controller, a preset third distance from a start point of the yield area in the direction of the target vehicle as the safety area.

According to an example, the determining of the driving strategy may include reducing, by the controller, the speed of the target vehicle to a speed corresponding to the merging section until just before entering the safety area, determining, by the controller, the speed of the target vehicle based on an average speed of vehicles on a merging road within an area from a start point of the safety area to an end point of the merging section after entering the safety area, detecting, by the controller, a vehicle expected to arrive at an end point of the merging section before the target vehicle among vehicles on a merging road if the target vehicle enters the yield area, reducing, by the controller, the speed of the target vehicle to a speed lower than a speed in the safety area, and stopping, by the controller, the target vehicle to allow a vehicle on a merging road to enter a main road if the target vehicle enters the stop area.

Accordingly, the processes of the method or algorithm described in relation to the examples of the present disclosure may be implemented directly by hardware executed by the processor 1100, a software module, or a combination thereof. The software module may reside in a storage medium (that is, the memory 1300 and/or the storage 1600), such as a RAM, a flash memory, a ROM, an EPROM, an EEPROM, a register, a hard disk, solid state drive (SSD), a detachable disk, or a CD-ROM. The exemplary storage medium is coupled to the processor 1100, and the processor 1100 may read information from the storage medium and may write information in the storage medium. In another method, the storage medium may be integrated with the processor 1100. The processor 1100 and the storage medium may reside in an application specific integrated circuit (ASIC). The ASIC may reside in a user terminal. In another method, the processor 1100 and the storage medium may reside in the user terminal as an individual component.

According to the examples of the present disclosure, it is possible to reduce the discomfort felt by occupants in the autonomous vehicle due to merging vehicles by setting at least one of a safety area, a yield area, and a stop area in each merging section for various types of merging sections on a road, and determining a driving strategy of the autonomous vehicle (or a target vehicle) for each area.

Although examples of the present disclosure have been described for illustrative purposes, those skilled in the art will appreciate that various modifications, additions and substitutions are possible, without departing from the scope and spirit of the disclosure. Therefore, the examples disclosed in the present disclosure are provided for the sake of descriptions, not limiting the technical concepts of the present disclosure, and it should be understood that such examples are not intended to limit the scope of the technical concepts of the present disclosure. The protection scope of the present disclosure should be understood by the claims below, and all the technical concepts within the equivalent scopes should be interpreted to be within the scope of the right of the present disclosure.

What is claimed is:

1. An apparatus for controlling autonomous driving of a vehicle, the apparatus comprising:
a controller configured to:
determine, in a merging section on a road, at least one area of a safety area, a yield area, or a stop area, wherein:
the safety area comprises a first part of the merging section designated for vehicles that have a right of way,
the yield area comprises a second part of the merging section designated for vehicles that should yield to traffic on the road, and
the stop area comprises a third part of the merging section designated for vehicles that should stop before merging onto the road, and
determine a driving strategy of the vehicle for the at least one area; and
a brake configured to, based on the driving strategy, adjust a speed of the vehicle.

2. The apparatus of claim 1, wherein the controller is configured to set the safety area in the merging section.

3. The apparatus of claim 2, wherein the controller is configured to set the safety area based on a speed limit of a main road and a speed limit of a merging road.

4. The apparatus of claim 2, wherein the controller is configured to:
before entering the safety area, reduce the speed of the vehicle to a speed associated with the merging section, and
determine, based on an average speed of vehicles on a merging road within the safety area, the speed of the vehicle.

5. The apparatus of claim 1, wherein the controller is configured to set the safety area and the yield area in the merging section.

6. The apparatus of claim 5, wherein the controller is configured to:
set the yield area based on a speed limit of a main road and a speed limit of a merging road, and
set a preset area from a start point of the yield area in a direction of the vehicle as an end point of the safety area.

7. The apparatus of claim 5, wherein the controller is configured to:
before entering the safety area, reduce the speed of the vehicle to a speed associated with the merging section, and
determine, determine the speed of the target vehicle based on an average speed of vehicles on a merging road within an area from a start point of the safety area to an end point of the merging section after entering the safety area.

8. The apparatus of claim 5, wherein the controller is configured to:
detect another vehicle expected to arrive at an end point of the merging section before the vehicle on the merging section enters the yield area, and
reduce the speed of the vehicle to a speed lower than a speed associated with the safety area.

9. The apparatus of claim 1, wherein the controller is configured to set the safety area, the yield area, and the stop area in the merging section.

10. The apparatus of claim 9, wherein the controller is configured to:
set a preset first distance from an end point of the merging section in a direction of the vehicle as a start point of the stop area,
set a preset second distance from a start point of the stop area in the direction of the vehicle as an end point of the yield area, and
set a preset third distance from a start point of the yield area in the direction of the vehicle as an end point of the safety area.

11. The apparatus of claim 9, wherein the controller is configured to:
before entering the safety area, reduce the speed of the vehicle to a speed associated with the merging section, and
determine, based on an average speed of vehicles from a start point of the safety area to an end point of the merging section, the speed of the vehicle.

12. The apparatus of claim 9, wherein the controller is configured to:
detect another vehicle expected to arrive at an end point of the merging section before the vehicle enters the yield area, and
reduce the speed of the vehicle to a speed lower than a speed associated with the safety area.

13. The apparatus of claim 9, wherein the controller is configured to stop, based on the vehicle entering the stop area, the vehicle to allow another vehicle on the merging section to enter a main part of the road.

14. A method performed by an apparatus for controlling autonomous driving of a vehicle, the method comprising:
determining, in a merging section on a road, at least one area of a safety area, a yield area, and a stop area, wherein:
the safety area comprises a first part of the merging section designated for vehicles that have a right of way,
the yield area comprises a second part of the merging section designated for vehicles that should yield to traffic on the road, and
the stop area comprises a third part of the merging section designated for vehicles that should stop before merging onto the road;
determining a driving strategy of the vehicle for the at least one area; and
adjusting, based on the driving strategy, a speed of the vehicle.

15. The method of claim 14, wherein the determining the driving strategy comprises:
setting, based on a speed limit of a main part of the road and a speed limit of the merging section, the safety area in the merging section;
before entering the safety area, reducing the speed of the vehicle to a speed associated the merging section; and
determining, based on an average speed of vehicles on the safety area, the speed of the vehicle.

16. The method of claim 14, wherein the determining the driving strategy comprises:
setting, based on a speed limit of a main part of the road and a speed limit of the merging section, the yield area;
setting a preset distance from a start point of the yield area in a direction of the vehicle as an end point of the safety area;
before entering the safety area, reducing the speed of the vehicle to a speed associated with the merging section; and
determining, based on an average speed of vehicles from a start point of the safety area to an end point of the merging section, the speed of the vehicle.

17. The method of claim 16, wherein the determining the driving strategy comprises:
detecting another vehicle expected to arrive at an end point of the merging section before the vehicle on the merging section enters the yield area; and
reducing the speed of the vehicle to a speed lower than a speed associated with the safety area.

18. The method of claim 14, wherein the determining the driving strategy comprises setting the safety area, the yield area, and the stop area in the merging section.

19. The method of claim 18, wherein the setting the safety area, the yield area, and the stop area comprises:
setting a preset first distance from an end point of the merging section in a direction of the vehicle as a start point of the stop area;
setting a preset second distance from a start point of the stop area in the direction of the vehicle as an end point of the yield area; and
setting a preset third distance from a start point of the yield area in the direction of the vehicle as an end point of the safety area.

20. The method of claim 19, wherein the determining the driving strategy comprises:
before entering the safety area, reducing the speed of the vehicle to a speed associated with the merging section;
determining, based on an average speed of vehicles from a start point of the safety area to an end point of the merging section, the speed of the vehicle;
detecting another vehicle expected to arrive at an end point of the merging section before the vehicle enters the yield area;
reducing the speed of the vehicle to a speed lower than a speed associated with the safety area; and
stopping, based on the vehicle entering the stop area, the vehicle to allow the other vehicle to enter a main part of the road.
